(19) United States
(12) Patent Application Publication
(10) Pub. No.: US 2009/0313228 A1
(43) Pub. Date: Dec. 17, 2009

(54) METHOD AND SYSTEM FOR CLUSTERING

(76) Inventors: Roopnath Grandhi, Sunnyvale, CA (US); Neelakantan Sundaresan, Mountain View, CA (US)

Correspondence Address: SCHWEGMAN, LUNDBERG & WOESSNER/EBAY, P.O. BOX 2938, MINNEAPOLIS, MN, 55402, US

(21) Appl. No.: 12/484,154

(22) Filed: Jun. 12, 2009

Related U.S. Application Data
(60) Provisional application No. 61/061,461, filed on Jun. 13, 2008.

(51) Int. Cl. G06F 17/30

(52) U.S. Cl. 707/3; 707/E17.108

(57) ABSTRACT

Methods and a system for search engine index clustering are described. In an embodiment, a search is performed based on a search query received from a client machine to obtain a list of items. Clusters and their descriptions are retrieved from a cluster index, and the search query is associated with one of the cluster descriptions. An item database is queried with the associated cluster description to identify item sets among the clusters, and a response to the search query is provided to the client machine based on the identified item sets.

### RELATED APPLICATIONS

This application is related to and hereby claims the priority benefit of U.S. Provisional Patent Application No. 61/061,461 filed Jun. 13, 2008 and entitled “Method and System for Clustering,” which is hereby incorporated herein by reference in its entirety.

### TECHNICAL FIELD

This application relates generally to the field of network-based queries and, more specifically, to the field of search engines.

### BACKGROUND

Search engines may index terms in a document into an inverted index so that when a user types in a query, the qualifying documents can be retrieved based upon the terms in the query. Popular search queries may return thousands of results that are hard to navigate to find relevant results. Furthermore, since many queries are generic, it is difficult to determine an order in which the user desires results.

### BRIEF DESCRIPTION OF THE DRAWINGS

In the following detailed description of example embodiments of the invention, reference is made to the accompanying drawings which form a part hereof, and which are shown by way of illustration only, specific embodiments in which the invention may be practiced. It is to be understood that other embodiments may be utilized and structural changes may be made without departing from a scope of the present invention.

Some embodiments are illustrated by way of example and not limitation in the figures of the accompanying drawings in which:

FIG. 1 is a block diagram of an exemplary network-based system, according to example embodiments;

FIG. 2 is a block diagram of an example query subsystem that may be deployed within the system of FIG. 1 according to an example embodiment;

FIGS. 3 and 4 are flowcharts illustrated a method for query processing according to an example embodiment;

FIG. 5 is an example query clustering diagram according to an example embodiment;

FIGS. 6 and 7 are flowcharts illustrating a method for query processing according to an example embodiment;

FIGS. 8-10 are example query clustering diagrams according to an example embodiment;

FIG. 11 is a network diagram depicting a network system, according to an embodiment, having a client-server architecture configured for exchanging data over a network;

FIG. 12 is a block diagram illustrating an example embodiment of multiple networks and marketplace applications, which are provided as part of the network-based marketplace; and

FIG. 13 is a block diagram representation of a machine in the example form of a computer system within which a set of instructions for causing the machine to perform any one or more of the methodologies discussed herein may be executed.

### DETAILED DESCRIPTION

Example methods and systems for clustering are described. In the following description, for purposes of explanation, numerous specific details are set forth in order to provide a thorough understanding of example embodiments. It will be evident, however, to one skilled in the art that embodiments of the present invention may be practiced without these specific details.

Therefore, the description that follows includes illustrative systems, methods, techniques, instruction sequences, and computing machine program products that embody the present invention. In the following description, for purposes of explanation, numerous specific details are set forth to provide an understanding of various embodiments of the inventive subject matter. It will be evident, however, to those skilled in the art that embodiments of the inventive subject matter may be practiced without these specific details. Further, well-known instruction instances, protocols, structures, and techniques have not been shown in detail.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below focus on aspects of clustering, the embodiments are given merely for clarity in disclosure.

In an example embodiment, a search query is received. A search is performed based on the search query to obtain a list of items. The list of items is provided to a clustering engine. A plurality of item sets is received from the clustering engine. A response is provided to the search query based on the receiving of the plurality of item sets.

In another example embodiment, a search query is received. A search is performed based on the search query to obtain a list of items. A plurality of item sets is identified from the list of items based on a clustering technique. A response is provided to the search query based on the identifying of the plurality of item sets.

In another example embodiment, a search query is received. A search is performed based on the search query to obtain a list of items. The list of items is provided to a clustering engine. A plurality of item sets is received from the clustering engine. The plurality of item sets for the search query is indexed. An additional search query is received. A search is performed based on the indexing of the plurality of item sets. A response to the search query is provided based on the performing of the search.

In another example embodiment, a search query is received. A search is performed based on the search query to obtain a list of items. A plurality of item sets is identified from the list of items based on a clustering technique. The plurality of item sets for the search query is indexed. An additional search query may be received. A search is performed based on the indexing of the plurality of item sets. A response to the search query is provided based on the performing of the search.

In another example embodiment, search results are clustered into groups of similar items and each cluster is named. In a two-level interface, the first level may show the cluster names, and clicking on the cluster names may show the items in the clusters. Additionally, the clusters may be hierarchical. The clusters may be created dynamically (in real time), or static cluster indices may be created and clusters identified from the indices in real time.

In another example embodiment, the created index is used for search, navigation, merchandising, classification, advertising and the like.

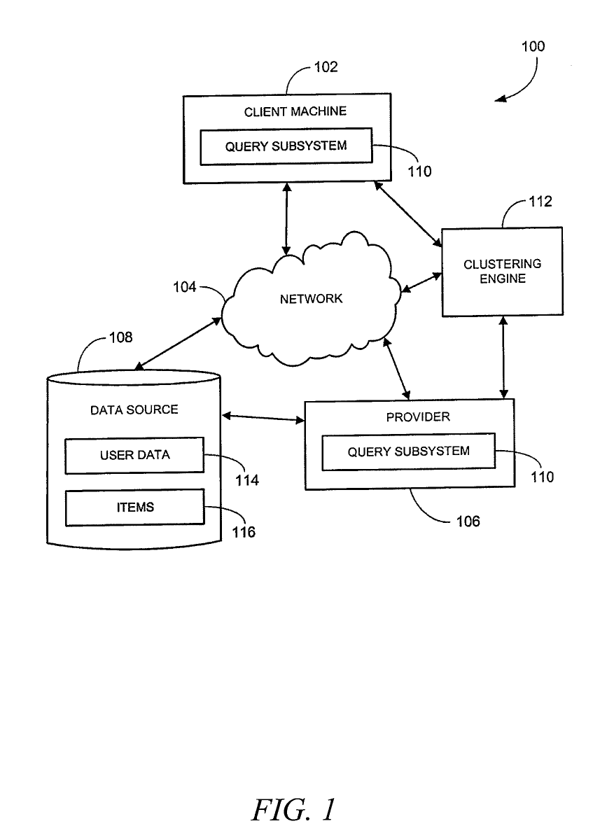

FIG. 1 illustrates an example system 100 in which a client machine 102 is in communication with a provider 106 over a network 104. A user operating the client machine 102 may communicate with the provider 106 or a data source 108 to make queries to the provider 106.

Examples of the client machine 102 include a set-top box (STB), a receiver card, a mobile telephone, a personal digital assistant (PDA), a display device, a portable gaming unit, and a computing system; however other devices may also be used.

The network 104 over which the client machine 102 and the provider 106 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional or later developed wired and wireless networks may also be used.

The provider 106 may also be in communication with the data source 108. The data source 108 may include user data 114 or items 116. The user data 114 may include information regarding users of the provider 106. The items may include items available for sale through the provider 106, such as documents, video, or the like.

The provider 106 or the client machine 102 may include a query subsystem 110 that receives and provides a response to a search query. A clustering engine 112 may receive a list of items and provide receiving item sets (e.g., clusters) from the provider 106 based on the application of a clustering technique (e.g., K-means).

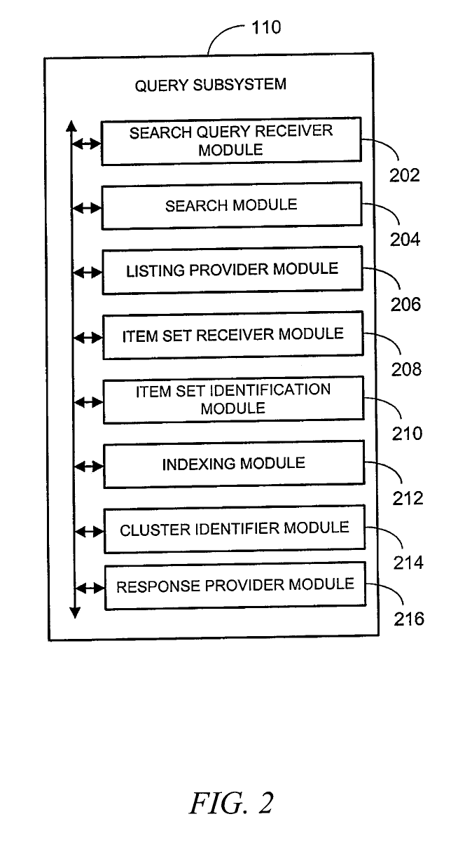

FIG. 2 illustrates an exemplary embodiment of the query subsystem 110 that is deployed in the provider 106 or the client machine 102 of the system 100 (see FIG. 1) or otherwise deployed in another system (not shown). The query subsystem 110 may include a search query receiver module 202, a search module 204, a listing provider module 206, an item set receiver module 208, an item set identification module 210, an indexing module 212, a cluster identifier module 214, or a response provider module 216. Other modules may also be included.

The search query receiver module 202 module receives a search query or an additional search query. The search module 204 performs a search based on the search query to obtain a list of items (or records), a cluster identifier, or on the indexing of item sets.

The list provider module 206 provides the list of items (or records) to the clustering engine 112. The item set receiver module 208 receives item sets from the clustering engine 112. The item set identification module 210 identifies item sets from the list of items based on a clustering technique.

The indexing module 212 indexes the item sets for the search query. The cluster identifier module 214 associates a cluster identifier with a description of the indexed item sets or identifies the cluster identifier for the additional search query based on the description.

The response provider module 216 provides a response to the search query based on the receiving of the item sets, identifying of the item sets or the performing of the search.

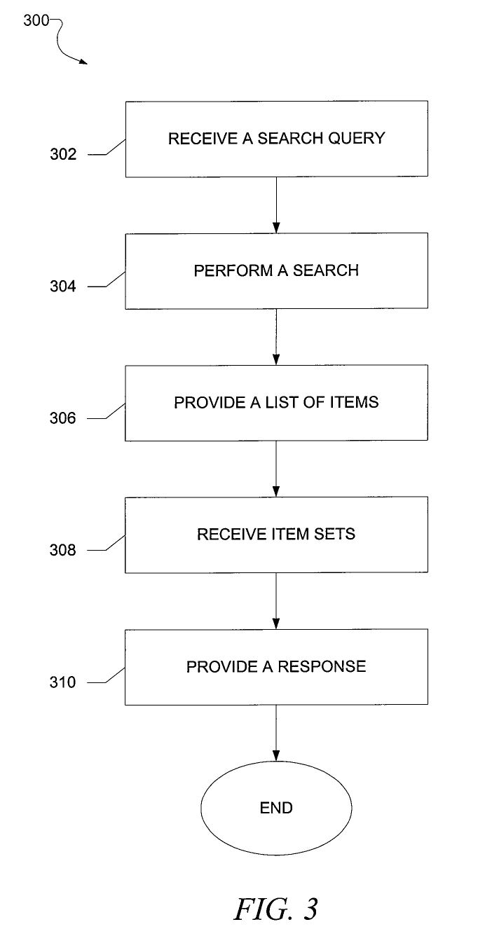

With concurrent reference now to FIGS. 1 and 3, a method 300 for query processing according to an example embodiment is illustrated. The method 300 is performed by the provider 106 or the client machine 102 of the system 100 (see FIG. 1) or is otherwise performed.

A search query is received at block 302. At block 304, a search is performed based on the search query to obtain a list of items.

The list of items is provided to the clustering engine 112 at block 306. Item sets are received from the clustering engine 112 at block 308.

A response to the search query is provided based on the receiving of the item sets at block 310.

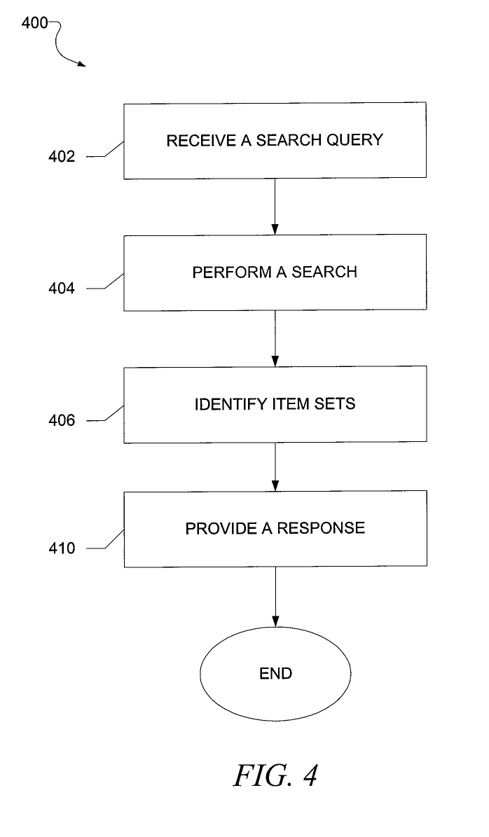

FIG. 4 illustrates a method 400 for query processing according to an example embodiment. The method 400 is performed by the provider 106 or the client machine 102 of the system 100 (see FIG. 1) or is otherwise performed.

A search query is received at block 402. At block 404, a search is performed based on the search query to obtain a list of items (or records).

Item sets are identified from the list of items based on a clustering technique at block 406. A single factor or multiple factors may be used for the clustering technique. For example, the factors may include item title, item category, item attributes, item price, or the like.

A response is provided to the search query based on identification of the item sets at block 408. The use of clustering may improve, in an example embodiment, navigation of the search result provided by the response.

In an example embodiment, information may not be stored during the performance of the methods 300, 400. Rather, the clustering may be provided on a given list of items as needed.

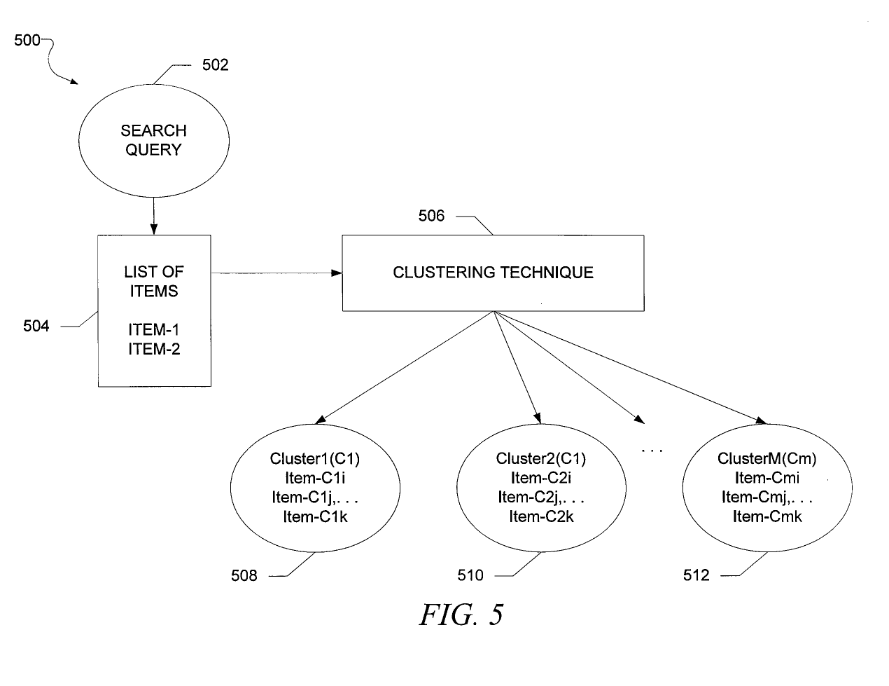

FIG. 5 illustrates an example query clustering diagram 500 according to an example embodiment. The query clustering diagram 500 may reflect, in an example embodiment, the performance of the methods 300, 400. However, different clustering diagrams may also reflect the methods 300, 400.

The query clustering diagram 500 is an example of real time clustering when a clustering technique is applied on the fly to a list of search results items 504 for a search query 502. A clustering technique 506 may output clusters 508-512 with each cluster associated with a group of items from the list of search results items 504.

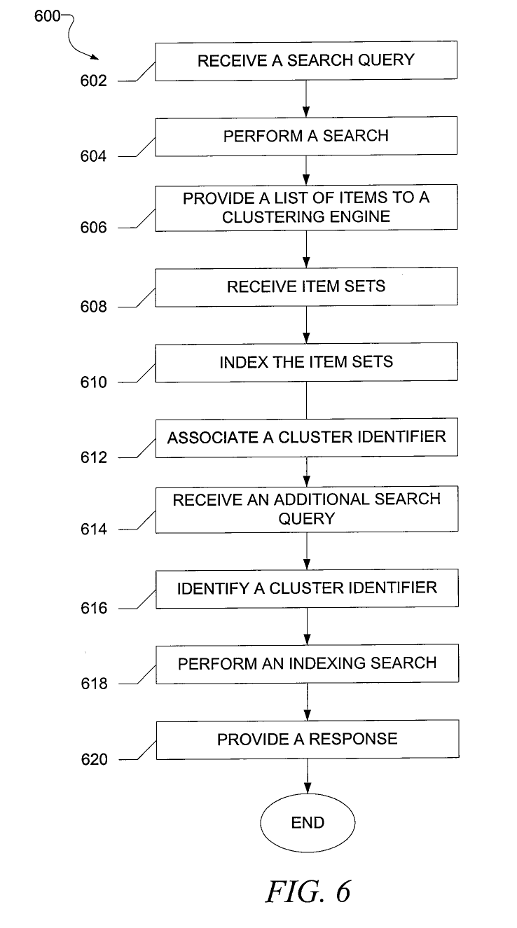

FIG. 6 illustrates a method 600 for query processing according to an example embodiment. The method 600 is performed by the provider 106 (FIG. 1) or the client machine 102 of the system 100 (see FIG. 1) or is otherwise performed.

A search query is received at block 602. A search is performed based on the search query to obtain a list of items (or records) at block 604.

The list of items is provided to the clustering engine 112 (FIG. 1) at block 606. Item sets are received from the clustering engine 112 at block 608.

The item sets for the search query are indexed at block 610. A cluster identifier is associated with a description of indexing the item sets at block 612.

An additional search query is received at block 614. The cluster identifier is identified for the additional search query based on the description at block 616.

A search is performed based on the indexing of the item sets or the cluster identifier at block 618. A response to the search query is provided based on the performing of the search at block 620.

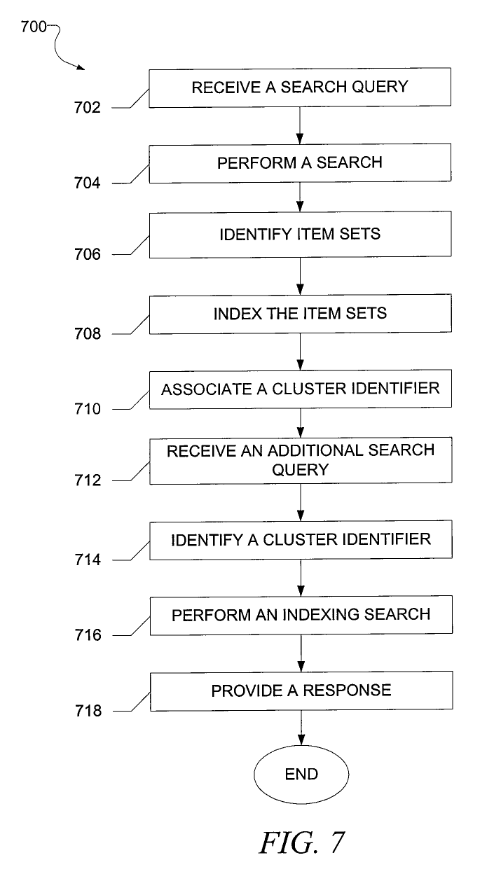

FIG. 7 illustrates a method 700 for query processing according to an example embodiment. The method 700 is performed by the provider 106 or the client machine 102 of the system 100 (see FIG. 1) or is otherwise performed.

A search query is received at block 702. A search is performed based on the search query to obtain a list of items (or records) at block 704.

Item sets are identified from the list of items based on a clustering technique at block 706. The item sets for the search query are indexed at block 708. A cluster identifier is associated with a description of the indexing the item sets at block 710.

An additional search query is received at block 712. The cluster identifier is identified for the additional search query based on the description at block 714.

A search is performed based on the indexing of the item sets or the cluster identifier at block 716.

A response to the search query is provided based on the performing of the search at block 718.

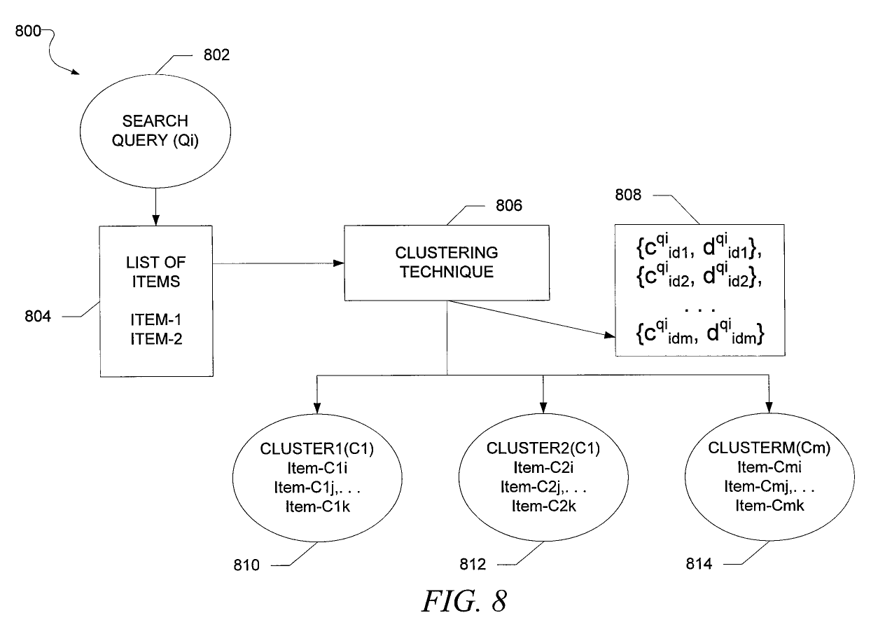

FIG. 8 illustrates an example query clustering diagram 800 according to an example embodiment. The query clustering diagram 800 may reflect, in an example embodiment, the performance of the methods 600, 700. However, different clustering diagrams may also reflect the methods 600, 700.

In offline clustering, the list of items offline is processed in batch mode and a cluster id and description are associated with each of the clusters. FIG. 8 provides an example of offline processing which associates the search query Qi 802 to clusters C1, C2 . . . Cm 810-814 using a clustering technique 806. Each cluster Ci is associated with a unique cluster id Cid and description of the cluster did. Each cluster is described by several properties of the cluster, which may, for example, be:

{keywords:
Attributes:
Category:
Product reference id:
etc. . .}

These cluster properties can correspond to metadata found in the item listings.

FIG. 8 illustrates two different approaches to cluster indexing. A first approach is to store a list of items 804 associated with the cluster Ci along with the description of the cluster. In this approach, if the items expire or become invalid, the clustering process is run again on a new list of items to get item information attached to the clusters.

Another approach is to store cluster descriptions 808 in the cluster index. In real time, when items belonging to a cluster are sought, the item database is queried with the cluster description to obtain the current active items belonging to that cluster. For example, if the cluster description consists of just key words, a real time search query may be to an item database to obtain the current active items belonging to that cluster.

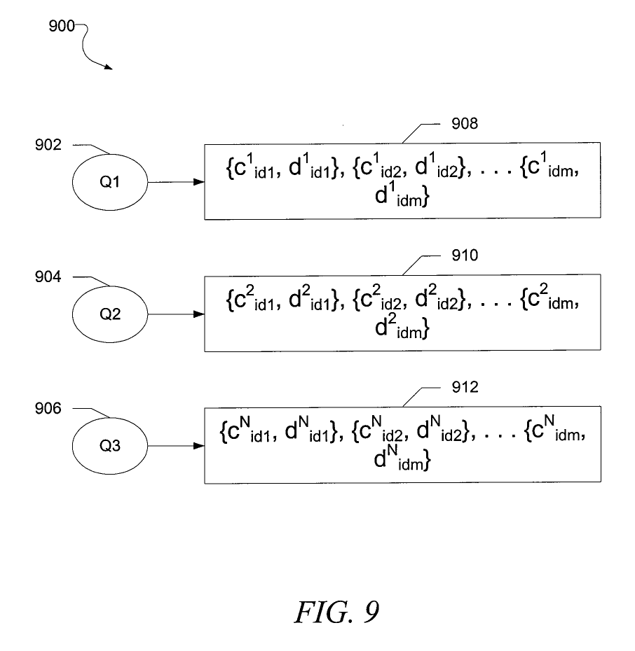

FIG. 9 illustrates an example query clustering diagram 900 according to an example embodiment. The query clustering diagram 900 may reflect, in an example embodiment, the performance of the methods 600, 700. However, different clustering diagrams may also reflect the methods 600, 700.

FIG. 9 describes how a cluster index is generated by repeating an offline process on each unique search query Qi 902, 904, 906. Mappings associated with the search queries 902, 904, 906 and associated clusters 908, 910, 912 are stored in the data source 108 (FIG. 1) as a cluster index or may be otherwise stored in a different manner.

Each cluster description along with the properties of the cluster may consist of weights. For example, one such weight could be a relevance weight which determines how relevant cluster Ci is to query Qi.

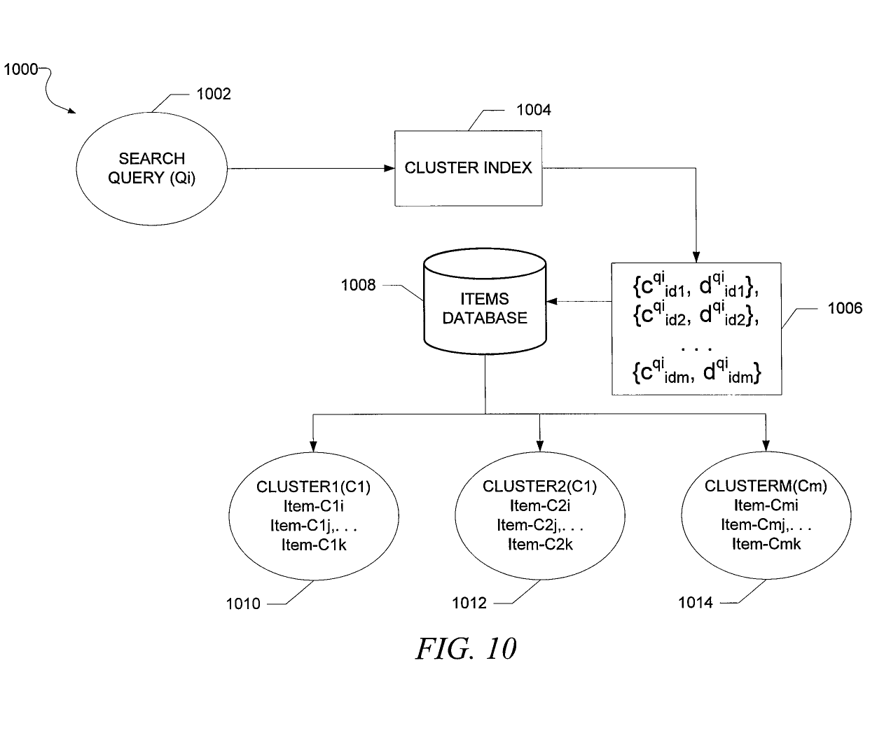

FIG. 10 illustrates an example query clustering diagram 1000 according to an example embodiment. The query clustering diagram 1000 may reflect, in an example embodiment, the performance of the methods 600, 700. However, different clustering diagrams may also reflect the methods 600, 700.

FIG. 10 describes how a cluster index 1004 is used to perform the clustering in real time. When a search query Qi 1002 is received in real time, associated cluster ids and descriptions 1006 are retrieved from the cluster index 1004, and then a query is made to an item database 1008 with the cluster description in order to populate the associated cluster 1010, 1012, 1014 with items.

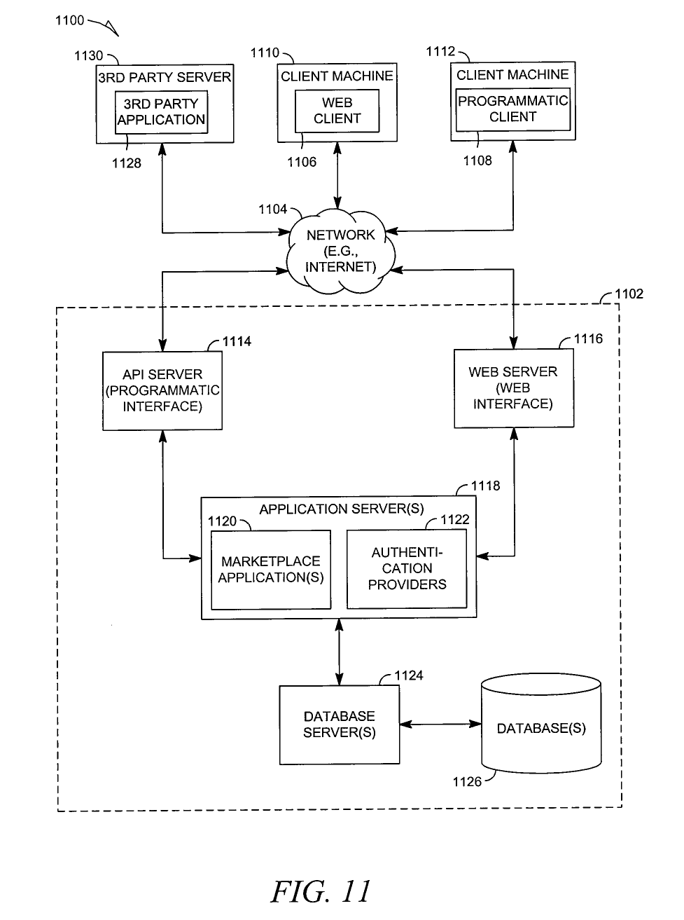

FIG. 11 is a network diagram depicting a client-server system 1100, within which one example embodiment is deployed. By way of example, a network 1104 may include the functionality of the network 104, the provider 106 or the clustering engine 112 is deployed within an application server 1118, and the client machine 102 may include the functionality of a client machine 1110 or a client machine 1112. The system 100 may also be deployed in other systems.

A networked system 1102, in the example forms of a network-based marketplace or publication system, provides server-side functionality, via a network 1104 (e.g., the Internet or Wide Area Network (WAN)) to one or more clients. FIG. 11 illustrates, for example, a web client 1106 (e.g., a browser, such as the Internet Explorer® browser developed by Microsoft® Corporation of Redmond, Wash.), and a programmatic client 1108 executing on respective client machines 1110 and 1112. An Application Program Interface (API) server 1114 and a web server 1116 are coupled to, and provide programmatic and web interfaces respectively to, one or more application servers 1118. The application servers 1118 host one or more marketplace applications 1120 and authentication providers 1122. The application servers 1118 are, in turn, shown to be coupled to one or more database servers 1124 that facilitate access to one or more databases 1126.

The marketplace applications 1120 may provide a number of marketplace functions and services to users that access the networked system 1102. The authentication providers 1122 may likewise provide a number of payment services and functions to users. The authentication providers 1122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 1120. While the marketplace 1120 and authentication 1122 providers are shown in FIG. 11 to both form part of the networked system 1102, in alternative embodiments the authentication providers 1122 may form part of a payment service that is separate and distinct from the networked system 1102.

Further, while the client-server system 1100 shown in FIG. 11 employs a client-server architecture, embodiments of the present invention are of course not limited to such an architecture, and could equally well find application in a distributed, or peer-to-peer, architecture system, for example. The marketplace 1120 and authentication 1122 providers could also be implemented as standalone software programs, which need not have networking capabilities.

The web client 1106 accesses the marketplace 1120 and authentication 1122 providers via the web interface supported by the web server 1116. Similarly, the programmatic client 1108 accesses the various services and functions provided by the marketplace 1120 and authentication 1122 providers via the programmatic interface provided by the API server 1114. The programmatic client 1108 may, for example, be a seller application (e.g., the TurboLister™ application developed by eBay Inc., of San Jose, Calif.) to enable sellers to author and manage listings on the networked system 1102 in an off-line manner, and to perform batch-mode communications between the programmatic client 1108 and the networked system 1102.

FIG. 11 also illustrates a third party application 1128, executing on a third party server machine 1130, as having programmatic access to the networked system 1102 via the programmatic interface provided by the API server 1114. For example, the third party application 1128 may, utilizing information retrieved from the networked system 1102, support one or more features or functions on a website hosted by the third party. The third party may, for example, provide one or more promotional, marketplace or payment functions that are supported by the relevant applications of the networked system 1102.

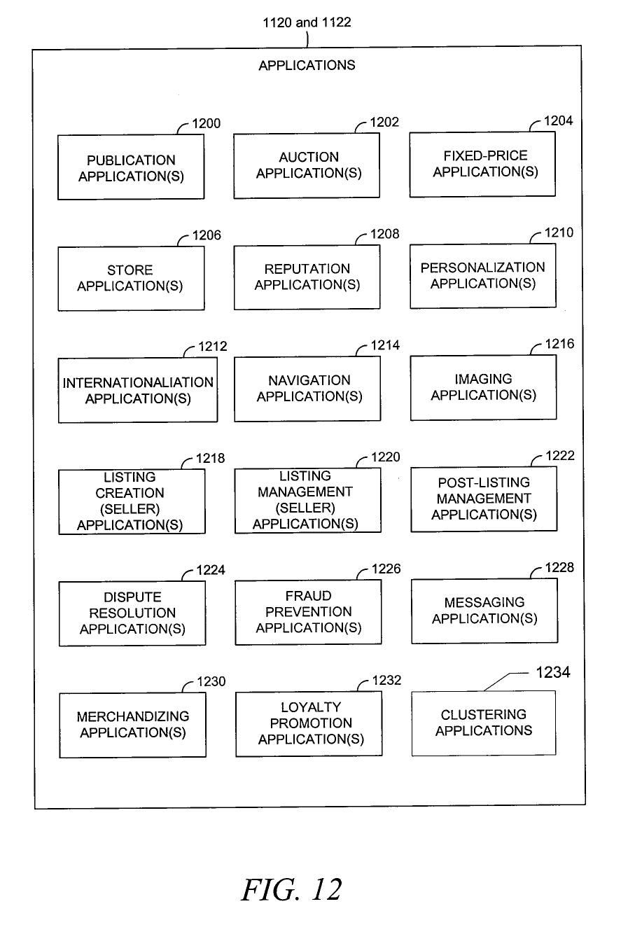

FIG. 12 is a block diagram illustrating multiple applications (e.g., the marketplace applications 1120 and the authentication providers 1122) that, in one example embodiment, are provided as part of the networked system 1102 (see FIG. 11). The applications may be hosted on dedicated or shared server machines (not shown) that are communicatively coupled to enable communications between server machines. The applications themselves are communicatively coupled (e.g., via appropriate interfaces) to each other and to various data sources, so as to allow information to be passed between the applications or so as to allow the applications to share and access common data. The applications may furthermore access the one or more databases 1126 via the one or more database servers 1124.

The networked system 1102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 1120 are shown to include at least one publication application 1200 and one or more auction applications 1202 which support auction-format listing and price setting mechanisms (e.g., English, Dutch, Vickrey, Chinese, Double, Reverse auctions etc.). The various ones of the auction applications 1202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 1204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, California) may be offered in conjunction with auction-format listings, and allow a buyer to purchase goods or services, which are also being offered for sale via an auction, for a fixed-price that is typically higher than the starting price of the auction.

Store applications 1206 allow a seller to group listings within a “virtual” store, which may be branded and otherwise personalized by and for the seller. Such a virtual store may also offer promotions, incentives and features that are specific and personalized to a relevant seller.

Reputation applications 1208 allow users that transact, utilizing the networked system 1102, to establish, build and maintain reputations, which may be made available and published to potential trading partners. Consider that where, for example, the networked system 1102 supports person-to-person trading, users may otherwise have no history or other reference information whereby the trustworthiness and credibility of potential trading partners may be assessed. The reputation applications 1208 allow a user, for example through feedback provided by other transaction partners, to establish a reputation within the networked system 1102 over time. Other potential trading partners may then reference such a reputation for the purposes of assessing credibility and trustworthiness.

Personalization applications 1210 allow users of the networked system 1102 to personalize various aspects of their interactions with the networked system 1102. For example a user may, utilizing an appropriate one of the personalization applications 1210, create a personalized reference page at which information regarding transactions to which the user is (or has been) a party may be viewed. Further, an appropriate one of the personalization applications 1210 may enable a user to personalize listings and other aspects of their interactions with the networked system 1102 and other parties.

The networked system 1102 may support a number of marketplaces that are customized, for example, for specific geographic regions. A version of the networked system 1102 may be customized for the United Kingdom, whereas another version of the networked system 1102 may be customized for the United States. Each of these versions may operate as an independent marketplace, or may be customized (or internationalized or localized) presentations of a common underlying marketplace. The networked system 1102 may accordingly include a number of internationalization applications 1212 that customize information (or the presentation of information) by the networked system 1102 according to predetermined criteria (e.g., geographic, demographic or marketplace criteria). For example, the internationalization applications 1212 may be used to support the customization of information for a number of regional websites that are operated by the networked system 1102 and that are accessible via respective web servers 1116.

Navigation of the networked system 1102 may be facilitated by one or more navigation applications 1214. For example, a search application (as an example of a navigation application) may enable key word searches of listings published via the networked system 1102. A browse application may allow users to browse various category, catalogue, or system inventory structures according to which listings may be classified within the networked system 1102. Various other navigation applications may be provided to supplement the search and browsing applications.

In order to make listings available via the networked system 1102 as visually informing and attractive as possible, the marketplace applications 1120 may include one or more imaging applications 1216 utilizing which users may upload images for inclusion within listings. The imaging applications 1216 also operate to incorporate images within viewed listings. The imaging applications 1216 may also support one or more promotional features, such as image galleries that are presented to potential buyers. For example, sellers may pay an additional fee to have an image included within a gallery of images for promoted items.

Listing creation applications 1218 allow sellers conveniently to author listings pertaining to goods or services that they wish to transact via the networked system 1102, and listing management applications 1220 allow sellers to manage such listings. Specifically, where a particular seller has authored or published a large number of listings, the management of such listings may present a challenge. The listing management applications 1220 provide a number of features (e.g., auto-relisting, inventory level monitors, etc.) to assist the seller in managing such listings. One or more post-listing management applications 1222 also assist sellers with a number of activities that typically occurs post-listing. For example, upon completion of an auction facilitated by one or more auction applications 1202, a seller may wish to leave feedback regarding a particular buyer. To this end, one or more of the post-listing management applications 1222 may provide an interface to one or more reputation applications 1208, so as to allow the seller conveniently to provide feedback regarding multiple buyers to the reputation applications 1208.

Dispute resolution applications 1224 provide mechanisms whereby disputes arising between transacting parties may be resolved. For example, the dispute resolution applications 1224 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention applications 1226 implement fraud detection and prevention mechanisms to reduce the occurrence of fraud within the networked system 1102.

Messaging applications 1228 are responsible for the generation and delivery of messages to users of the networked system 1102, such messages for example advising users regarding the status of listings at the networked system 1102 (e.g., providing “outbid” notices to bidders during an auction process or to provide promotional and merchandising information to users). Respective messaging applications 1228 may utilize any one of a number of message delivery networks and platforms to deliver messages to users. For example, messaging applications 1228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1230 support various merchandising functions that are made available to sellers to enable sellers to increase sales via the networked system 1102. The merchandising applications 1230 also operate the various merchandising features that may be invoked by sellers, and may monitor and track the success of merchandising strategies employed by sellers.

The networked system 1102 itself, or one or more parties that transact via the networked system 1102, may operate loyalty programs that are supported by one or more loyalty/promotions applications 1232. For example, a buyer may earn loyalty or promotions points for each transaction established or concluded with a particular seller, and may be offered a reward for which accumulated loyalty points can be redeemed.

The clustering application 1234 may be utilized in the networked system 1102 of FIG. 11 for search results, merchandising, advertising, or the like. The clustering application 1234 may, in an example embodiment, be applied on a list of items that are mapped to a query context. A cluster index may be generated that maps the query context to cluster descriptions. At real time when the query context occurs, a corresponding cluster description may be retrieved from the cluster index. For example, if the specific use case is to navigate the items sold by a specific seller, the query context may be the seller id, and the cluster index that maps the seller id to cluster descriptions may be generated in offline processing. At run-time, when navigating the items sold by a specific seller, the corresponding cluster descriptions may be received from the cluster index and the clusters may be populated with the corresponding items sold by the specific seller. The cluster index may thereby be used to simulate the dynamic or real time clustering.

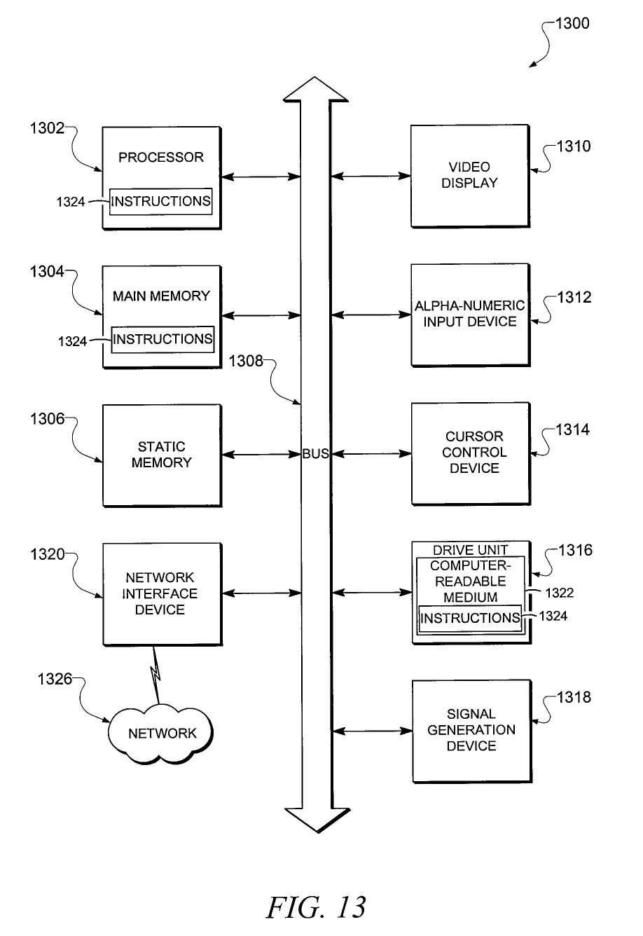

FIG. 13 shows a diagrammatic representation of machine in the example form of a computer system 1300 within which a set of instructions may be executed causing the machine to perform any one or more of the methods, processes, operations, or methodologies discussed herein. The provider 106 may operate on one or more computer systems 1300. The client machine 102 may include the functionality of the one or more computer systems 1300. The provider 106 or the clustering engine 112 may be deployed on the one or more computer systems 1300.

In an example embodiment, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1300 includes a processor 1302 (e.g., a central processing unit (CPU) a graphics processing unit (GPU) or both), a main memory 1304 and a static memory 1306, which communicate with each other via a bus 1308. The computer system 1300 may further include a video display unit 1310 (e.g., a liquid crystal display (LCD) or a cathode ray tube (CRT)). The computer system 1300 also includes an alphanumeric input device 1312 (e.g., a keyboard), a cursor control device 1314 (e.g., a mouse), a drive unit 1316, a signal generation device 1318 (e.g., a speaker) and a network interface device 1320.

The drive unit 1316 includes a machine-readable medium 1322 on which is stored one or more sets of instructions (e.g., software 1324) embodying any one or more of the methodologies or functions described herein. The software 1324 may also reside, completely or at least partially, within the main memory 1304 or within the processor 1302 during execution thereof by the computer system 1300, the main memory 1304 and the processor 1302 also constituting machine-readable media.

The software 1324 may further be transmitted or received over a network 1326 via the network interface device 1320.

While the machine-readable medium 1322 is shown in an example embodiment to be a single medium, the term “machine-readable medium” should be taken to include a single medium or multiple media (e.g., a centralized or distributed database, or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, various exemplary embodiments of methods and systems for clustering have been described. Although embodiments of the present invention have been described with reference to specific example embodiments, it will be evident that various modifications and changes may be made to these embodiments without departing from the scope of the embodiments of the invention. Accordingly, the specification and drawings are to be regarded in an illustrative rather than a restrictive sense.

What is claimed is:

1. A network-based method to cluster search results, the method comprising:
receiving a search query from a client machine over a network;
performing a search based on the search query to obtain a list of items;
retrieving a plurality of clusters and a plurality of cluster descriptions from a cluster index;
associating the search query with a cluster description of the plurality of cluster descriptions;
querying an item database with the cluster description to identify a plurality of item sets from the plurality of clusters; and
providing a response to the search query, based on identification of the plurality of item sets, to the client machine over the network.

2. A network-based system to cluster search results, the system comprising:
a search query receiver module to receive a search query from a client machine over a network;
a search module to perform a search based on the search query to obtain a list of items;
an item set identification module to identify a plurality of item sets from the list of items using a clustering technique; and
a response provider module to provide a response to the search query, based on identification of the plurality of item sets, to the client machine over the network.

3. The system of claim 2, further comprising:
an item database to store a plurality of item listings, a plurality of clusters, and a plurality of cluster descriptions, the plurality of item listings associated with the plurality of clusters.

4. The system of claim 3, further comprising:
a clustering engine to query the item database with a cluster description of the plurality of cluster descriptions to obtain one or more item listings of the plurality of item listings.

5. A machine-readable storage medium embodying instructions which, when executed by a machine, cause the machine to execute a method comprising:
receiving a search query from a client machine over a network;
performing a search based on the search query to obtain a list of items;
retrieving a plurality of clusters and a plurality of cluster descriptions from a cluster index;
associating the search query with a cluster description of the plurality of cluster descriptions;
querying an item database with the cluster description to identify a plurality of item sets from the plurality of clusters; and
providing a response to the search query, based on identification of the plurality of item sets, to the client machine over the network.
